(19) United States
(12) Patent Application Publication
(10) Pub. No.: US 2005/0244201 A1
(43) Pub. Date: Nov. 3, 2005

(54) Method for producing an enhanced gloss toner image on a substrate

(76) Inventors: Muhammed Aslam, Rochester, NY (US); Dinesh Tyagi, Fairport, NY (US); Rodney R. Bucks, Webster, NY (US)

Correspondence Address: Lawrence P. Kessler;Patent Department, NexPress Solutions LLC, 1447 St. Paul Street, Rochester, NY, 14653-7103, US

(21) Appl. No.: 10/837,050

(22) Filed: Apr. 30, 2004

(51) Int. Cl. G03G 15/20

(52) U.S. Cl. 399/341

(57) ABSTRACT

A method for producing an enhanced gloss electrophotographic toner image on a substrate by passing a substrate bearing a fusible toner particle image through a fusing zone to produce a substrate bearing a fused toner image, passing the substrate bearing the fused toner image through a cooling zone to produce a cooled substrate bearing the fused toner mage and passing the cooled substrate bearing the fused toner image to a release zone where a cooled substrate bearing an enhanced gloss image is released, wherein the fusible toner particle image is covered by a clear toner layer.

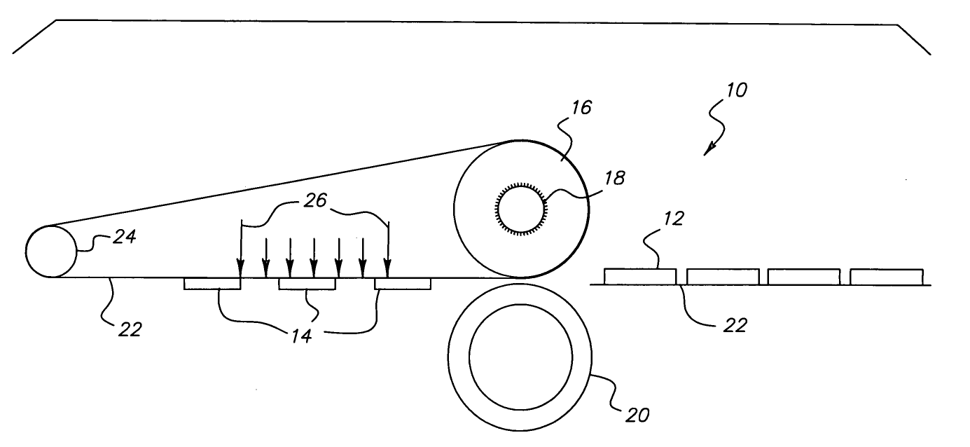

### FIELD OF THE INVENTION

This invention relates to a method for producing an enhanced gloss electrophotographic toner image on a substrate by passing a substrate bearing an image comprising colored fusible toner particles through a fusing zone to fuse the fusible toner particles and produce a substrate bearing a fused toner image, passing the substrate bearing the fused toner image through a cooling zone to produce a cooled substrate bearing an enhanced gloss; fused toner image; and, releasing the cooled substrate bearing the enhanced gloss fused toner image. The fusible toner particle image contain is covered by a fusible clear toner layer.

### BACKGROUND OF THE INVENTION

Various methods are known for fusing toner particle images on substrates. In conventional fusing systems, one or both of the fuser roller and the pressure roller may be heated and are somewhat compliant to create a wide nip to allow sufficient heating area. Such conventional fusing systems typically provide gloss levels less than about 20 at a 20-degree measurement. Also when using coating papers, the wide nip causes overheating and thereby contributes to blisters as the receiving sheet leaves the nip. Unfortunately, the wide nip prevents obtaining sufficiently high pressure to remove the toner image relief in these materials.

Finishing color images comprising fusible toner particles has been attempted in typical fusing systems. In these fusing systems, as noted above, typically the gloss is relatively low. As a result systems for fusing colored images using methods and apparatus that result in fusing the black images to the substrate, do not provide the desired gloss. Alternate methods have been used to produce enhanced gloss images by fusing the toner particle images and, thereafter passing the substrate bearing the fused toner image through a cooling zone and then passing the cooled substrate bearing the fused toner image to a release zone where the cooled substrate bearing an enhanced gloss image is released. In typical fusing processes it has been found that when conventional toners are used, the use of release additives such as silicone oil are required. The oil results in the presence of defects in the color image and in the surrounding area of the substrate when the alternate methods are used. There are a variety of reasons for these defects and it is considered that certain of these defects relates to the formation of a haze, which is a low color saturation or dot in the image visible from certain viewing angles and under certain lighting conditions. This defect results in lower gloss and reduced image density.

A second defect resulting from the presence of the oil is oil-laden images (ghosts). The oil presence on an imaged and fused sheet diffuses unevenly into the sheet fibers. Therefore when such a sheet comes in contact with a glossing belt (cooling zone) it leaves an oil imprint relating to the image on the belt, which is picked up by the following sheet showing a ghost image of the images of the preceding sheet. Ripples and wiggles are also attributed to the presence of oil on the sheet since it reduces friction on the belt glosser nip and therefore can cause image ripples or wrinkles in the sheet.

Various processes for using belt glossers to produce higher gloss images on substrates are shown in U.S. Pat. Nos. 5,089,363; 5,256,507; 5,258,256; and 5,778,295. These patents are hereby incorporated in their entirety by reference and disclose apparatus and methods for the use of belt glossers to improve the gloss of the image on substrates especially in, but not limited to, colored images. These references also disclose various materials conventionally used in such processes.

Accordingly a continuing effort has been directed to the development of a method for using a belt glosser to fuse, cool and release a substrate bearing an image so that the gloss of the image may be enhanced without the need for or the detrimental effects of oil.

### SUMMARY OF THE INVENTION

According to the present invention, an enhanced gloss image is obtained without the use of or detriments of oil by a method for producing an enhanced gloss electrophotographic toner image on a substrate, the method comprising: passing a substrate bearing an image comprising colored fusible toner particles through a fusing zone to fuse the fusible toner particles and produce a substrate bearing a fused toner image; passing the substrate bearing the fused toner image through a cooling zone to produce a cooled substrate bearing the fused toner mage; and, passing the cooled substrate bearing the fused toner image to a release zone where a cooled substrate bearing an enhanced gloss image is released, wherein the image comprising fusible toner particles is covered by a clear toner layer.

The present invention further comprises a method for producing an enhanced gloss image on a substrate by positioning an image comprising colored fusible toner particles on a substrate, fusing the toner particles in a fuser to produce a fused image on the substrate, cooling the substrate bearing the fused image and releasing the coated substrate bearing the fused toner image, the improvement comprising positioning a layer of clear toner particles over the image comprising colored fusible toner particles.

### BRIEF DESCRIPTION OF THE FIGURE

The Figure is a schematic diagram of a belt glossing system for fusing, cooling and releasing substrates bearing an image so that the image has a higher gloss.

### DETAILED DESCRIPTION OF THE INVENTION

In the practice of the present invention, conventional toners may be used to produce image prints.

A wide variety of polymers useful as binders are known. Particularly useful are vinyl addition polymers, which may be linear, branched or lightly cross-linked. The most widely used condensation polymers are polyesters, which are polymers in which backbone recurring units are connected by ester linkages. Like the vinyl addition polymers, polyesters useful as binder polymers in toner particles can be linear, branched or lightly cross-linked. They can be fashioned from any of many different monomers, typically by polycondensation or monomers containing two or more carboxylic acid groups (or derivatives thereof, such as anhydride or ester groups) with monomers containing two or more hydroxy groups. Specific examples of useful binder polymers include olefin homopolymers and copolymers, such as polyethylene, polypropylene, polyisobutylene and polyisopentylene; polyfluoroolefins such as polytetrafluorethylene; polyhexamethylene adipamide, polyhexamethylene sebacamide and polycaprolactam; acrylic resins, such as polymethylmethacrylate, polyacrylonitrile, polymethylacrylate, polyethylmethacrylate and styrene-methymethacrylate or ethylene-methyl acrylate copolymers, ethylene ethyl acrylate copolymers, ethylene-ethyl methacrylate copolymers, polystyrene and copolymers of styrene with unsaturated acrylic monomers of the type mentioned hereinbefore, cellulose derivatives, such as cellulose acetate, cellulose acetate butyrate, cellulose propionate, cellulose acetate propionate and ethyl cellulose; polyvinyl resins such as polyvinyl chloride, copolymers of vinyl chloride and vinyl acetate and polyvinyl butyral, polyvinyl alcohol, polyvinyl acetal, ethylene-vinyl acetate copolymers and ethylene-allyl copolymers such as ethylene-allyl alcohol copolymers, ethylene-allyl acetone copolymers, ethylene-allyl benzene copolymers ethylene-allyl ether copolymers, ethylene-acrylic copolymers and polyoxymethylene, polycondensation polymers, such as polyesters, polyurethane, polyamides and polycarbonates.

Conventional binders may be used in the toners of the present invention as well known to those skilled in the art. Further numerous colorant materials are well known for use for the production of colors based upon the use of magenta, cyan, yellow, and black colorants. Examples of such colorants are Hansa Yellow G (C.I. 11680) CI Yellow 12, CI Solvent Yellow 16, CI Disperse Yellow 33, Nigrosine Spirit soluble (C.I. 50415), Chromogen Black ETOO (C.I. 45170), Solvent Black 3 (C.I. 26150), Fuchsine N (C.I. 42510), C.I. Pigment Red 22, C.I. Solvent Red 19, C.I. Basic Blue 9 (C.I. 52015), Quinacridone C.I. Pigment Red 122 & 202, Lithol Rubine C.I. Pigment Red 57:1, C.I. Pigment Red 146, CI Pigment Yellow 185, CI Pigment Yellow 180 and Pigment Blue 15. Carbon black also provides a useful colorant.

The colorants may be present in the toner over a wide range such as from about 1 to about 20 weight percent of the toner. Good results are typically obtained when the amount is from about 1 to about 10 percent.

Further charge control agents suitable for use in the toners are disclosed, for example, in U.S. Pat. Nos. 3,893,935; 4,079,014; and 4,323,634. Charge control agents are generally employed in small quantities, such as from about 0.10 to about 3 wt. % of the toner and are more typically used in quantities from about 0.2 to about 2.5 wt. %. Typically the toner images are formed as known to the art by the use of carriers. Most carriers known to those skilled in the art are suitable for the formation of the color images.

No novelty is claimed in the toners used to form the color image on the substrate. These toners are conventional and are conventionally applied as known to those skilled in the art to form a black and white or a different or multi-color image. The image may be developed as known to those skilled in the art through a belt glossing system.

A belt glossing system 10 is shown in the Figure. This showing is schematic only and discloses only the features necessary to achieve the operational steps described since such apparatus and procedures are known to those skilled in the art.

A plurality of substrates 12 are passed via a conveyor 14 to a fusing section comprising a fuser roller 16, which may include a heater 18, and a pressure roller 20. The substrates are passed between rollers 16 and 18 and become adhered to a belt 22. As the substrates leave the fusing zone between rollers 16 and 18 they are retained on belt 22 and cooled. The cooling is shown schematically by arrows 26 and may be accomplished by any suitable means, such as the use of air, cooled air or the like. As the substrates cool, the images become more viscous and have a reduced elasticity. As a result when belt 22 passes around roller 24, which is desirably of a relatively small diameter, the substrates are released and collected for conveyance to a storage area or the like. Roller 24 is desirably of a relatively small diameter and is preferably smaller than rollers 16 and 20. The operation of such systems is well known to those skilled in the art. As discussed above, the presence of oil on the fuser roller to inhibit the removal of toner onto the surfaces of the fuser roller results in numerous detrimental affects as the substrates pass onward along belt 22 and result in image defects.

Accordingly to the present invention, positioning a clear toner layer over the image eliminates this difficulty. The clear toner layer is of a conventional composition, but without the presence of any colorant. Further this layer desirably includes from about 2.5 to about 10 wt. % of an aliphatic, olefinic, hindered or unhindered ester wax molecular having a weight of typically less than about 2000. This material serves readily to prevent the clear toner from adhering to the fuser roller surface and produces a high gloss image without defects.

The gloss of the image is determined to a large extent by the surface of the fuser rollers. Unfortunately, it is frequently necessary to provide surface features on the rollers resulting in less gloss on the image. Typically the gloss of the images produced using a conventional fuser roller is less than about 20. By the use of the fuser belt, which can have a high gloss surface that results in the presence of a high gloss image on the substrate, the gloss can be from about 20 to about 100 and is desirably from about 50 to about 100.

Typically the toner image is brought into pressure contact with the surface of the fusing member (belt) in the fusing zone. The temperature applied to fuse the toner particles causes the particles to fuse into a sintered mass that adheres to the substrate. Due to the relative flow characteristics of such toner particles the sintered mass has an uneven or rough surface of low surface reflectivity. Typically temperatures used in the fusing zone are less than about 140° C. and generally in the range of about 100° to 140° C., often 105° to 135° C., and preferably 115° to 130° C. The pressures used in combination with the aforementioned fusing temperatures include those conventionally employed in contact fusing processes. They are generally in the range of about 3 kg./cm² to about 15 kg./cm² and are often about 10 kg./cm².

The fusing member (belt) employed in the practice of this invention can be in any physical form suitable for applying heat in a face-to-face relationship with a toner pattern and maintaining that relationship through the cooling zone. Belt 22 is typically a continuous belt, although it could be in the form of plates. A continuous belt is preferred because this provides a straight, flat fusing path that reduces curl problems that can be introduced by a roller. The surface of the fusing member is generally smooth, although a texture surface can be used if the surface is not so rough that it reduces the overall gloss of the fused toner pattern to an undesirable level. When a continuous belt is employed, the belt must be reasonably flexible and heat resistant. It is preferably made with a material such a stainless steel or polyester that meet such criteria, such as a polyimide sold under the tradename of KAPTON. The outer surface of the fusing member which contacts the unfused toner image can comprise any of the materials known in the prior art to be suitable for use in such fusing surfaces, including aluminum, steel, various alloys as well as polymeric materials such as thermoset resins. Fusing members with fluoroelastomer surfaces can improve the release characteristics of the fuser member. In the practice of this invention because the toner images are cooled in the cooling zone to a level where they readily release from the fusing member without toner image surface of the fusing member. The toner image to be fused typically moves through the fusing zone at a velocity of at least about 2.5 cm./sec., normally about 2.5 to 10 cm./sec. The velocity is generally kept constant as the element bearing the toner image moves through the cooling and release zones.

In the cooling zone, cooling of the fused toner image is controlled so that it can be released at a temperature where no toner image offset occurs. The temperature of the fused image is generally reduced by at least about 40° C., often about 65° to 90° C., in the cooling zone. As previously indicated, cooling can conveniently be controlled simply by adjusting the velocity of the fusing member. For example, the velocity of a continuous belt or roll while cooling air is impinged upon the belt or the element, as illustrated in the Figure, although other cooling means such as a chill roll or plate could be used in place of air impingement. When a continuous belt is used as the fusing member, it usually is not necessary to press the element against the fusing member to maintain contact between the fusing member and the fused toner image because the image is heated in the fusing zone to a point where the fused image surface acts as an adhesive which temporarily bonds to the fusing member as the fused toner image moves through the cooling zone.

In the release zone the fused toner image is separated from the fusing member. Such release is not affected until the fusing member is cooled to a temperature where no toner image offset occurs. Such temperature is typically no more than about 75° C. and is normally in the range of about 30° to 60° C. The specific temperature used to achieve such separation will vary considerably as it depends upon the flow properties of the toner particles. The release temperature chosen is such that toner image adheres to the support and exhibits sufficient cohesiveness that it will not offset on the fuser member at the particular temperature used. Upon separation from the fusing member in the release zone, the fused toner image exhibits a degree of gloss that will vary considerably depending upon the specific processing conditions such as amount and duration of pressure and temperature and the vicoelastic characteristics of the toner particles used in the method of this invention. However, the gloss levels for fused toner images formed in this invention are typically at least 20 and often in the range of about 50 to 100. Such gloss levels are readily perceptible to the unaided eye but they can be measured by a specular glossmeter at 20° using conventional techniques well known to offset, i.e., there is no significant transfer of toner image to the those skilled in the art for this purpose, for example, the method described in ASTM-523-67.

A typical method utilizes a single reflectivity measurement, as of a type that measures the amount of light from a standard source that is specularly reflected in a defined path. A suitable device for this purpose is a Glossgard II 20° glossmeter (available commercially from Pacific Scientific, Inc., Silver Springs, Md.) which produces a reading on a standardized scale, of a specularly reflected ray of light having angles of incidence and reflection of 10° to the normal. The standard scale of such meter has a range from 0 to 100, the instrument being normally calibrated or adjusted so that the upper limit corresponds to a surface that has substantially less than the complete specular reflection of a true mirror. Reflectivity readings are indicated as gloss numbers.

As previously indicated herein, the method of this invention provides not only fused toner images having enhanced gloss but it can also provide transparencies having colored toner images on transparent supports, which images exhibit good color clarity. As known to those skilled in the art, color clarity can be defined as the ratio of specular to total transmitted light expressed in percent. Such color clarity can be conveniently determined by placing an image on a transparent support in an optical light path and separately measuring or reading the specular and totally transmitted light with a suitable device, e.g., a photometer.

Various conductive or nonconductive materials can be used as supports for the toner images fused in the method of this invention. Such supports are well known to those skilled in the art and include various metals such as aluminum and copper and metal-coated plastic films as well as organic polymeric films and various types of paper. Polyethylene terephthalate is an excellent transparent polymeric support use in forming transparencies.

By the method of the present invention with the use of the clear toner layer containing the wax, it is not necessary to use oils on the fuser roller. This eliminates the surface defects caused by the presence of oils. As well known, any or all of the colored toners can be used in the formation of a particular image on a substrate. Desirably the belt is a flat, smooth belt that produces a smooth, high gloss image on the substrate. The substrate is typically cooled by at least 40° and more typically from about 40° to about 90° C., before it is released from the belt by virtue of the belt's curvature as it moves around roller 24. Typically the gloss levels produced may be as high from about 50 to about 100.

According to the present invention, it is unnecessary to use oils at the fuser roller since the clear toner layer includes waxes that provide the required free release of the images. This process provides improved gloss characteristics to the images on the substrate as well as avoiding the problems resulting from the use of oil.

While the present invention has been described by reference to certain of its preferred embodiments, it is pointed out that the embodiments described are illustrative rather than limiting in nature and that many variations and modifications are possible within the scope of the present invention. Many such variations and modifications may be considered obvious and desirable by those skilled in the art based upon a review of the foregoing description of preferred embodiments.

1. A method for producing an enhanced gloss electrophotographic toner image on a substrate, the method comprising:
a) passing a substrate bearing an image comprising colored fusible toner particles through a fusing zone to fuse the fusible toner particles and produce a substrate bearing a fused toner image;
b) passing the substrate bearing the fused toner image through a cooling zone to produce a cooled substrate bearing the fused toner mage; and
c) passing the cooled substrate bearing the fused toner image to a release zone where a cooled substrate bearing an enhanced gloss image is released, wherein the image comprising fusible toner particles contains at least one colored toner layer covered by a clear toner layer.

2. The method of claim 1 wherein the colored toner is a black toner.

3. The method of claim 1 wherein the colored toner is a magenta toner.

4. The method of claim 1 wherein the colored toner is a cyan toner.

5. The method of claim 1 wherein the colored toner is a yellow toner.

6. The method of claim 1 wherein the colored toner comprises at least two of a magenta toner, a cyan toner, a yellow toner and a black toner.

7. The method of claim 1 wherein the image comprising fusible toner particles is fused at a temperature below about 200° C.

8. The method of claim 1 wherein the image comprising fusible toner particles is fused at a temperature from about 100° to about 140° C.

9. The method of claim 1 wherein the image comprising fusible toner particles is fused at a pressure from about 3 to about 15 kg/cm².

10. The method of claim 1 wherein the substrate bearing the fused image is cooled in the cooling zone to reduce the temperature of the substrate bearing the fused image by at least 40° C.

11. The method of claim 10 wherein the temperature reduction is from about 40 to about 90° C.

12. The method of claim 1 wherein the cooled substrate bearing the fused image is released at a temperature from about 30 to about 75° C.

13. The method of claim 1 wherein the gloss level of the image on the cooled substrate bearing an enhanced gloss image is from about 20 to about 100.

14. The method of claim 1 wherein the gloss level is from about 50 to about 100.

15. The method of claim 1 wherein the clear toner contains from about 2.5 to about 10 weight percent of an aliphatic, olefinic, hindered or unhindered ester wax.

16. The method of claim 1 wherein the aliphatic, olefinic, hindered or unhindered ester wax has an average molecular weight less than about 2000.

17. In a method for producing an enhanced gloss image on a substrate by positioning an image comprising colored fusible toner particles on a substrate, fusing the toner particles in a fuser to produce a fused image on the substrate, cooling the substrate bearing the fused image and releasing the coated substrate bearing the fused toner image, the improvement comprising positioning a layer of clear toner particles over the image comprising colored fusible toner particles.

18. The improvement of claim 17 wherein the colored toners comprise at least one of black, magenta, cyan, and yellow toners.

19. The improvement of claim 17 wherein the toners are fused at a temperature from about 100° to about 140° C.

20. The improvement of claim 17 wherein the enhanced gloss image has a gloss from about 20 to about 100.
